(19) United States
(12) Patent Application Publication
(10) Pub. No.: US 2011/0273370 A1
(43) Pub. Date: Nov. 10, 2011

(54) DEVICE FOR ENTERING CONTROL SIGNALS TO A PERIPHERAL UNIT

(75) Inventor: Tomas Öquist, Upplands Vasby (SE)

(73) Assignee: Perific Technolgies AB, Kista (SE)

(21) Appl. No.: 13/132,581

(22) PCT Filed: Dec. 4, 2009
(86) PCT No.: PCT/SE2009/051376

§ 371 Date: Jul. 20, 2011

(30) Foreign Application Priority Data
Dec. 4, 2008 (SE) 0802522-3

(51) Int. Cl. G06F 3/033

(52) U.S. Cl. 345/166; 345/163

(57) ABSTRACT

The invention pertains to a device for entering control signals to a peripheral unit. The device contains means which sense movements of the device relative to an essentially flat surface, such that movements of the device on the essentially flat surface fills the same function as the movements of a standard computer mouse. The part of the device graspable by a user is rotatable in a plane relative to the part of the device containing means for sensing movements relative to the essentially flat surface. The invention also concerns a combination of such a device and a peripheral unit.

### BACKGROUND OF THE INVENTION

The present invention relates to a device for entering control signals to a peripheral unit. The device is designed such that the user can generate control signals suitable to be transferred to said peripheral unit by moving the device on an essentially flat surface, such that the manipulation of the device fills the same function as the movement of a standard computer mouse. The device may thus be used for moving a cursor, an arrow or other computer controlled entity in different directions in a graphic user interface. The device includes means for sensing movements relative to the essentially flat surface. The part of the device that is grippable by the user is rotatable in a plane relative to the part of the device including means for sensing movements relative to the essentially flat surface. The invention also pertains to a combination of such a device and a peripheral unit.

Since many individuals spend a large part of their day in front of a computer it is important that the computer interaction be made as efficient and user friendly as possible, such that attritional wear and ergonomical problems can be avoided. It is of utmost importance that a computer environment be created which enables the user to work in relaxed and ergonomically appropriate positions.

It is well known that the conventional computer mouse may cause problems in the form of so-called repetitive strain injuries, RSI (also known as repetitive stress injuries, repetitive motion injuries, repetitive motion disorders or cumulative trauma disorders). These problems are strongly linked to how the computer mouse is gripped and the body position which the user must have to be able to operate the conventional computer mouse. Working with a conventional computer mouse is associated with static postures and postures being inappropriate for the user. By a conventional computer mouse is understood a mouse that the user grips with one hand and that then generates control commands to a peripheral unit/computer when being moved over a flat surface.

It is known that the problems with RSI are highly linked to the facts that the computer mouse typically is located a distance to the right or left of a centrally located keyboard and the user must extend his/her arm to reach it. Further, the angle of the hand relative to the table surface becomes disadvantageous when the mouse is gripped from above.

In the search for an optimal working posture it is therefore desirable that the user should be able to work with his/her hands straight in front of and close to his/her body when he/she is engaged with controlling the cursor on the computer display. However, using the conventional computer mouse straight in front of the body is associated with practical difficulties. Hence, alternative solutions are needed.

Today, there are numerous pointer solutions for the central type of control means. These are different concepts enabling the user to work with his/her hands in front of and close to his/her body. The central control means is here typically placed between the user and the keyboard.

The touch pad often used in portable computers fulfils some of the criteria placed by an ergonomical pointer solution. A touch pad must however be controlled by one finger working such that the contact surface towards the touch pad does not vary because any variations in the contact surface will also be interpreted as finger movements. This leads to a strained working posture and other ergonomical problems. The touch pad also has limitations regarding the highest possible precision. Moreover, it is not possible to use multiple fingers or fingers from both hands either, since the touch pad cannot handle contact surface variations.

A pointing device for performing the same function as a computer mouse consisting of a pointer stick built into a wrist support is known inter alia from WO0243046. A pointer stick arranged to be rotated and translated is used for controlling a pointer on a computer display. The pointer stick is further arranged so that an electric switch is activated when the pointer stick is depressed. An optical sensor is arranged to detect movements of the stick and then translate this information into information interpretable by a drive routine for a computer mouse as information concerning how the pointer shall be moved across an image display. The rotation is endless since the pointer stick's movement is without limits in that direction. Sideward movements of the pointer stick, which causes a leftward and rightward movement of the pointer of the image display, are limited. Thus, the pointer stick has mechanical side blockings. The device contains an endpoint detector that can relocate the pointer on the display if the pointer stick has reached an end position without the pointer having reached a desired position. A part of the stick being accessible through an opening in the wrist support can be manipulated by a user. The wrist support also functions as a support for the user's hands and arms. Furthermore, the device contains means for placing a keyboard at a suitable position and elevation relative to the pointer stick.

Devices where the control signal is generated by means of a pointing surface movable in a plane are also known. One such device is described in WO0206943 by Strömberg. A pointing surface movable in a plane is constituted by an endless loop moving around and along two parallel axes. Sensors in the device are arranged to detect the movements of the loop. One additional control signal can be generated by vertically depressing the surface.

Naturally, a standard computer mouse is likewise known. Such a computer mouse is designed to be moved on an essentially flat surface. The movements in different directions are detected and converted into electric signals used for moving for example a cursor or a pointer arrow on a computer display.

A standard computer mouse normally includes a ball that is rotated when the mouse is moved over a surface. The rotation of the ball can be detected by electrical or optical means. It is however also known that a computer mouse can be designed without using a ball. For instance, U.S. Pat. No. 6,281,882 B1 describes a computer mouse which optically detects the movement of the mouse on a surface without using a ball.

The above-described input devices have some disadvantages. It is true that the central type of pointer solution offers the possibility to work with the hands in front of the body and close to the body. However, the working posture becomes static and the precision in the central control means cannot reach the level of precision offered by the standard computer mouse. The central control means also occupies considerable space and limit how the place of work can be designed.

Using the standard computer mouse may lead to a static working posture which can cause overstrain of the arm and hand used to manipulate the mouse. The standard computer mouse is unsuitable to use straight in front of the body because then the directions for moving the mouse on the table do not coincide with the cursor movements, since a standard computer mouse used in front of the body will necessarily be held with a hand and arm where the directions do not coincide with the directions on the display. Moving a standard computer mouse held in front of and close to the body gives pointer movements in a coordinate system that is rotated relative to the one on the display.

A device that enables working with the hands straight in front of and close to the body and also offers the advantages of the standard computer mouse regarding precision is described below.

### SUMMARY OF THE INVENTION

One object of the invention is to offer a device of the kind specified in the first paragraph above and which enables a device providing the advantages that both the standard computer mouse and central devices have. By adding to a standard computer mouse the possibility to set the angle between the bottom part, where the sensor is located which detects movements relative to the surface on which the device is located, and the upper part gripped by the user, the device can be used as an ordinary mouse straight in front of and close to the user.

When the conventional computer mouse is moved on a surface, which typically is a table surface, the pointer moves on the display analogous to the movements of the mouse on the table surface. When the mouse is moved sideward the pointer also moves sideward on the display. When the mouse is moved forwards in the direction of the mouse the pointer is moved upwards. When the mouse is moved in the opposite direction the pointer is moved downwards on the display. The standard computer mouse is typically used and placed next to a keyboard. This way of controlling a pointer on a computer display is an accepted technique.

In the case where a user uses a conventional standard computer mouse straight in front of and close to the body the arm, and in its extension the mouse, will point leftwards of a user working with his/her right hand and rightwards of a user working with his/her left hand. The arm, the hand and in its extension the mouse are positioned at an angle relative to the table edge, typically between zero and forty-five degrees. When the user moves the mouse away from himself/herself, typically in a direction towards the display, in the direction which at normal use next to the keyboard means that the pointer moves upwards on the display, the pointer moves diagonally across the display. When the user moves the mouse towards himself/herself to control the pointer downwards on the display the pointer moves diagonally across the display in a direction opposite to the one in the foregoing example. Similar problems arise when the user moves the mouse sideward in front of the body. The pointer now moves diagonally across the display at an angle of approximately ninety degrees towards the two earlier examples.

The sensor that is located on the underside of the mouse measures the movement relative to the underlying surface. Conventional computer mice today use an optical sensor photographing the surface on top of which the mouse moves. By comparing the images that the sensor photographs the sensor can, based on image analysis, determine how the sensor moves on the surface. Control signals are then generated and sent to the peripheral unit, which typically is a computer, for controlling the pointer on the display.

In order to enable the user to experience that the movement of the mouse coincides with the movement on the display it is required that the coordinate systems for the operative surface of the mouse and the display are aligned with one another. A sideward movement of the mouse on the surface then gives a sideward movement on the display, and analogously a movement back and forth gives movement up and down on the display. This is true when the mouse is placed on the surface with its distal part turned away from the user. When using a standard computer mouse next to the keyboard the coordinate system will be correctly located and the pointer's movement on the surface is effected in analogy with the movements on the display.

When the conventional standard computer mouse is used straight in front of the body and its coordinate system thereby is rotated relative to the directions applicable when using the mouse next to the keyboard the coordinate system on the display will also be rotated. A sideward movement along the table edge does then not cause a sideward movement on the display however a diagonal movement of the pointer over the display.

In the case where the user works with the mouse straight in front of and close to his/her body the user may rotate the mouse on the table surface so that the mouse points away from the user and towards the display and the coordinate system is lined up correctly, such that the mouse on the surface and the pointer on the display move in analogy with one another. However, such a way of working requires a very strained working posture and is in reality not performable during any extended period of time.

In the case where a rolling ball is used as a sensor instead of optical sensor similar problems and undesired consequences arise as those described above.

By having a bottom part of the device as described below and above rotatable in a plane relative to the upper part gripped by the user the bottom part can be aimed so that the coordinate system is lined up correctly. Then the movement on the surface and the movement on the display will occur in analogy with one another in the same manner as when the conventional standard computer mouse is placed next to the keyboard with its front end aimed away from the user.

Different users will rotate the coordinate system of the mouse to various extent depending on how they direct their arm, how long the arm is, how far away from the body and how close to the keyboard they place the device. In any case, they can adjust the bottom part such that the coordinate system is aligned with the coordinate system on the display. A user having the mouse very close to the body and the arm almost parallel to the table edge will need to rotate the coordinate system almost ninety degrees relative to the upper part in order to align the coordinate system of the device with the coordinate system on the display. A user using the device further away from the body will need to adjust the bottom part with a smaller angle than in the above example to align the coordinate system of the device with the coordinate system on the display. In the case where the device is to be used in a conventional manner next to the keyboard, the bottom part is aimed such that the front side of the bottom part and the front side of the upper part are aimed in the same direction. In this example the device operates and is used as a conventional standard computer mouse.

In other words, the device can be described as a standard computer mouse having a bottom part being rotatable in a plane relative to the upper part.

According to one advantageous embodiment the means rendering the upper part rotatable in the plane relative to the bottom part is constituted by two toothed wheels. One of the parts is connected to an inner toothed wheel and the other part is connected to an outer toothed wheel. The toothed wheels are made of a material having resilient properties. When one of the parts is rotated relative to the other part the teeth may jump over one another with some resistance. Said one of the parts of the upper part and the bottom part is then fixed connected to the inner toothed wheel and the other part of the upper part and the bottom part is fixed connected to the outer toothed wheel. The teeth provide a locking such that the upper part does not rotate unintentionally relative to the bottom part. In response to a predetermined rotational force the teeth may jump over one another and the bottom part and the upper part are rotated relative to one another.

According to another preferred embodiment the means rendering the upper part rotatable in the plane relative to the bottom part is constituted by a cylinder and a friction locking bow. At least the friction locking bow is made of a resilient material. One of the bottom part and the upper part is then fixed connected to the cylinder. The other part is fixed connected to the friction locking bow that forms a circle when the ends of the bow are pressed together. The size of the bow and the circle is selected so that it fits exactly around the cylinder when the ends of the bow are pressed together. The bow further has a locking mechanism enabling locking of the bow in the position at which the ends of the bow are pressed against one another and the bow contacts the cylinder and with friction is locked when the cylinder and the bow contact one another.

According to yet another advantageous embodiment the means rendering the upper part rotatable in the plane relative to the bottom part is constituted by a cylinder having multiple grooves, with a surrounding limitation having a groove lockable by a wedge inserted into any of the grooves on the cylinder. The wedge can be moved down into the grooves or be moved out from the groove. When the wedge is positioned in the groove the cylinder and the surrounding limitation are locked to one another. When the wedge is removed from the groove it is possible to rotate the cylinder inside the surrounding limitation. Either of the upper part and the bottom part is fixed connected to the cylinder and the other part is fixed connected to the surrounding limitation. When the wedge is inserted into the locking position the bottom part and the upper part are locked to one another.

According to yet another advantageous embodiment the upper part is designed such that it covers a part of or the entire bottom part. In this embodiment a part of or the entire upper part extends all the way down to the essentially flat surface on which the device rests. The bottom part is then completely or partially enclosed by the upper part. The bottom part which contains means for detecting movements relative to the essentially flat surface is also in this embodiment rotatable in the plane relative to the upper part. The means for enabling the rotation in the plane of the upper part relative to the bottom part are constituted by the same types of means used in those cases where the upper part does not completely or partially cover the bottom part

According to another advantageous embodiment a combination of these possible implementations is also possible and foreseen to lock and rotate the bottom part.

According to a second advantageous embodiment the bottom part has a marking showing the user how the coordinate system for the sensor that detects movements over the essentially flat surface is oriented. By such a marking that preferably shows the forward direction on the device, which corresponds to upwards on the display of the peripheral unit, the user may in a straight-forward manner estimate if a correct angle has been selected for the rotation of the upper part relative to the bottom part.

According to another second advantageous embodiment the marking on the bottom part is a line showing the forward and backward directions on the surface corresponding to upwards and downwards on the display of the peripheral unit.

According to yet another second advantageous embodiment the marking on the bottom part is an arrow showing the forward direction on the surface which corresponds to upwards on the display of the peripheral unit.

According to another advantageous embodiment means showing the user how the coordinate system is oriented are constituted by, in the case where the upper part entirely or partially encloses the bottom part, means being fixed connected to the bottom part which contains means detecting movements relative to the essentially flat surface, and have an extension enabling visual detection in an opening in the upper part. The part of the means being fixed connected to the bottom part, which is visually detectable for the user, contains a direction designation showing the user how the coordinate system for the sensor detecting motion over the essentially flat surface is oriented.

According to yet another advantageous embodiment means showing the user how the coordinate system is oriented are constituted by, in the case where the upper part entirely or partially encloses the bottom part, means being fixed connected to the bottom part, which contains means detecting movements relative to the essentially flat surface, and having an extension being visually detectable through at least one part of the upper part that is transparent. The part of the means being fixed connected to the bottom part, which is visually detectable for the user, contains a direction designation showing the user how the coordinate system for the sensor detecting motion over the essentially flat surface is oriented.

According to another advantageous embodiment a combination of these possible implementations for designating a direction indication is also possible and foreseen.

It is advantageous if the device contains additional means for generating additional control signals to the peripheral unit. Buttons may then be placed on the upper part. These buttons are mechanically connected to electric switches which thus may generate additional control signals to the peripheral unit. Typically, this possibility is used to accomplish signals corresponding to “left click” and “right click” on a conventional computer mouse. Adding other types of additional means for generating additional control signals to the peripheral unit are foreseen. By adding a scroll wheel on the upper part the user is provided with a possibility to create “scroll signals” to the peripheral unit.

It is further advantageous if the upper part of the device is inclined such that the user does not put his/her hand flat onto the upper part. It is known that it is ergonomically advantageous if the upper part of a standard computer mouse inclines such that the hand can be positioned in a more neutral posture. For a user controlling a computer mouse with his/her right hand this means that the upper part shall be lower on the rightmost side and higher on the leftmost side. It is thus advantageous that the upper part, in the case where the device is controlled by a user's right hand, of the device is gripped at approximately an angle of 45 degrees relative to the surface with the rightmost part of the hand closest to the surface. In the case where the device is controlled by the user's left hand the upper part of the device should, for the same reasons, be inclined leftwards.

According to one preferred embodiment of the invention, the sensor that detects motion of the device relative the essentially flat surface is of the same type of optical sensor that is used in the standard computer mouse mentioned above. In this implementation the optical sensor detects the movement of the device relative to the essentially flat surface. The motion detected by the sensor then generates control signals to the peripheral unit. The optical sensor is a camera with an associated processing unit. The camera captures the pattern of the surface and the processing unit may then determine how this pattern is moved.

It is possible to attain the same advantages with other types of motion detecting means than the optical sensor mentioned above.

It should further be mentioned that the device may be incorporated into different kinds of solutions. For example the device may preferably be integrated as a part of a mouse pad with a wrist support. It is likewise possible to implement solutions where the device is not integrated with any other parts.

The invention also pertains to a combination of the device according to any of the above-described embodiments and a peripheral unit. The combination is arranged or programmed so that the movement of said device on an essentially flat surface causes the peripheral unit to control at least one entity of the peripheral unit. The peripheral unit may for example include a computer and a display. The combination may be arranged or programmed so that the manipulation of said device or the movement of the device on said surface causes a cursor or other graphical entity to move on said display. According to the combination, the device is thus actively connected with a peripheral unit for controlling some entity.

### BRIEF DESCRIPTION OF THE DRAWINGS

FIG. 1 shows a side view of an embodiment of the device according to the invention.

FIG. 2 schematically shows a view from above of an embodiment according to the invention.

FIG. 3 schematically shows a view from above of an embodiment according to the invention.

FIG. 4 schematically shows a cut away view of an embodiment according to the invention.

FIG. 5 schematically shows a view from above of an embodiment according to the invention.

FIG. 6 schematically shows a view from above of an embodiment of a part of the invention.

FIG. 7 schematically shows a view from above of an embodiment of a part of the invention.

FIG. 8 schematically shows a perspective view of an embodiment of the invention with a peripheral unit.

### DESCRIPTION OF EMBODIMENTS OF THE INVENTION

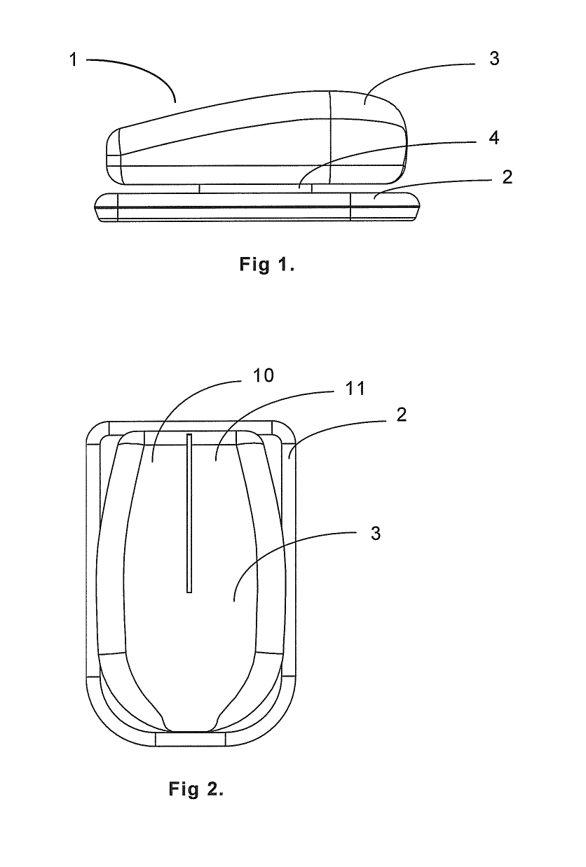

FIG. 1 shows a side view of an embodiment of the device 1. The bottom part 2 is connected to the upper part 3 via the means 4 which enable rotation of the bottom part 2 relative to the upper part 3. The bottom part contains means, which detect and sends control signals to a peripheral unit 5, when the device 1 is moved on the essentially flat surface. The upper part 3 is the part gripped by the user. The user may by moving the upper part 3 being connected to the bottom part 2 move the device 1 on the essentially flat surface and thereby control a cursor on a display of the peripheral unit.

FIG. 2 schematically shows an embodiment from above of the invention. In this example, the bottom part 2 is aimed in the same direction as the upper part 3. The upper part 3 contains means 10, 11 that can generate additional control signals, which for example correspond to left click and right click created by a standard computer mouse, to the peripheral unit.

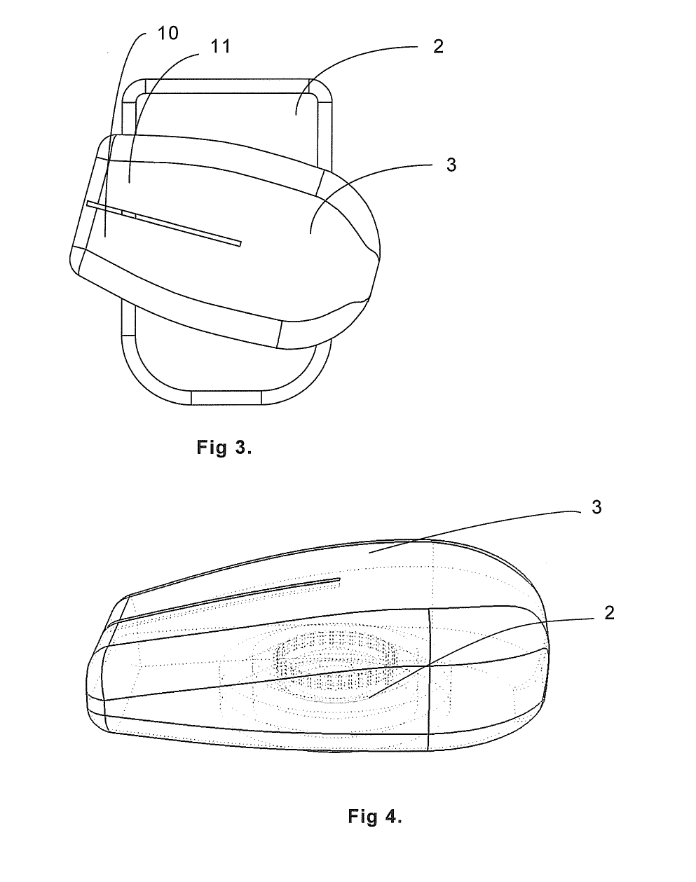

FIG. 3 schematically shows an embodiment from above of the invention. In this example, the bottom part 2 is aimed in a different direction than the upper part 3. The upper part 3 contains means 10, 11 that can generate additional control signals, which for example correspond to left click and right click created by a standard computer mouse, to the peripheral unit.

FIG. 4 shows a cut away of an embodiment in which the upper part 3 completely surrounds the bottom part 2 and extends all the way down to the essentially flat surface. Means 4 enabling rotation of the bottom part 2 relative to the upper part 3 connect the bottom part 2 with the upper part 3. A portion of the bottom part 2 is visually detectable through an opening in the upper part 3.

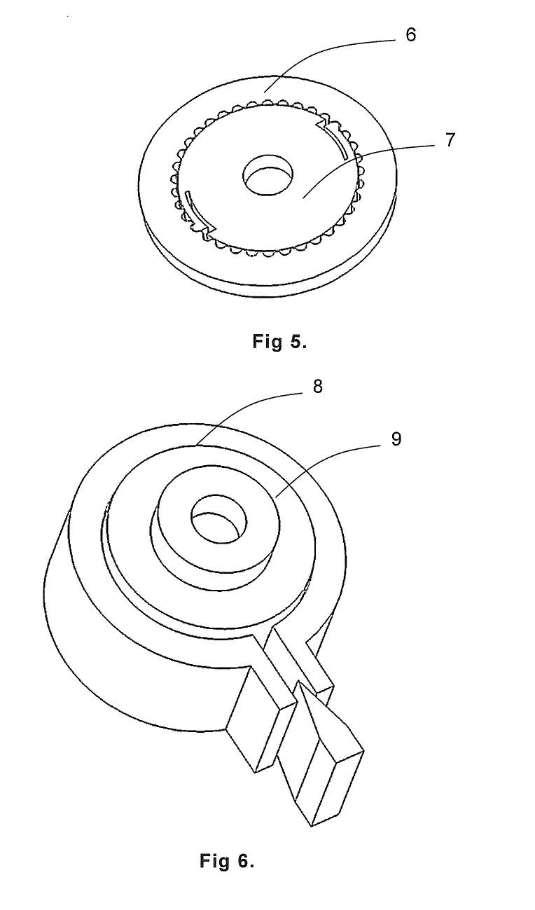

FIG. 5 schematically shows a first embodiment from above of a part of the invention. The part shown is the means 4 enabling rotation of the bottom part 2 in a plane relative to the upper part 3. In this case, the means 4 is implemented by two toothed wheels 6, 7. The material of the toothed wheels 6, 7 is resilient and it is thereby possible to rotate the inner toothed wheel 6 relative to the outer toothed wheel 7. The material of the toothed wheels 6, 7 may be plastics or some other flexible material. The bottom part 2 is fixed connected to one of the toothed wheels 6, 7 and the upper part 3 is fixed connected to other one of the toothed wheels 6, 7.

FIG. 6 schematically shows a second embodiment from above of a part of the invention. The part shown is the means 4 enabling rotation of the bottom part 2 in a plane relative to the upper part 3. In this case, the means 4 is implemented by a cylinder 8 and a friction lock 9. The material of the friction lock 9 is resilient and lockable and the inner cylinder 8 in the friction lock and is thereby possible to rotate relative to the outer part. The material of the cylinder 8 and the friction lock 9 may be plastics or another flexible material. The bottom part 2 is fixed connected to one of the cylinder 8 or the friction lock 9 and the upper part 3 is fixed connected to the other of the cylinder 8 or the friction lock 9.

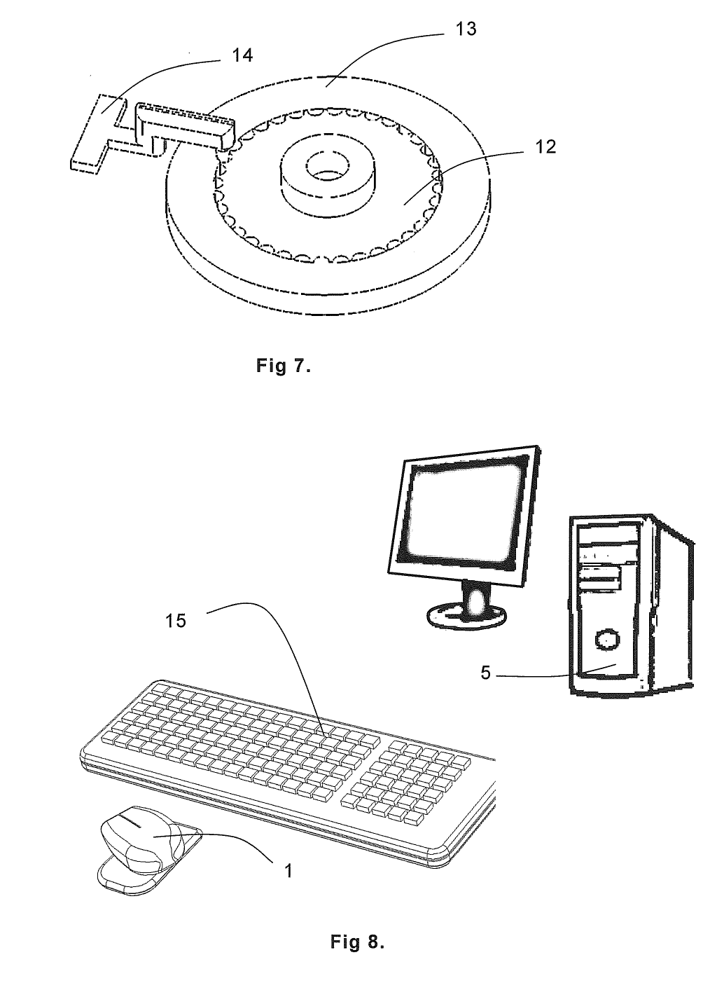

FIG. 7 schematically shows a second embodiment from above of a part of the invention. The part shown is the means 4 enabling rotation of the bottom part 2 in a plane relative to the upper part 3. In this case, the means 4 is implemented by a cylinder with multiple grooves 12, a surrounding limitation having a groove 13 and a wedge 14 that may lock the cylinder 12 relative to the surrounding limitation 13. When the wedge is removed from the grooves the cylinder may rotate relative to the surrounding. When the wedge is positioned in a groove the cylinder is locked relative to the surrounding limitation. In order to enable locking of the cylinder relative to the surrounding limitation a groove of the cylinder must be placed immediately in front of the groove of the surrounding limitation. Either the upper part or the bottom part is fixed connected to the cylinder and the other part is fixed connected to the surrounding limitation.

FIG. 8 shows a perspective view of the device 1 where the device has been connected to a peripheral unit 5 and is used together with a keyboard 15.

The invention is not limited to the embodiments described however may be varied and modified within the scope of the following claims.

1. A device for entering control signals to a peripheral unit, the device comprising a bottom part and an upper part connected to one another,
the bottom part comprising means for sensing movements of the bottom part relative to an essentially flat surface causing the device to generate control signals for controlling the movement of a cursor on a computer display suitable for being transferred to said peripheral unit such that the movement of the device on an essentially flat surface fulfils the same function as the movement of a computer mouse,
the upper part being designed to be gripped and manipulated by a user,
the upper part comprising at least one means for generating at least one additional control signal suitable to be transferred to the peripheral unit,
means for connecting the upper part with the bottom part and enabling the bottom part to be rotated in a plane and be locked in different angles relative to the upper part.

2. A device according to claim 1, wherein said means for connecting the upper part with the bottom part and enabling the bottom part to be rotated in the plane and be locked in different angles relative to the upper part are two toothed wheels.

3. A device according to claim 1, wherein said means for connecting the upper part with the bottom part and enabling the bottom part to be rotated in the plane and be locked in different angles relative to the upper part is a cylinder being lockable with a friction lock.

4. A device according to claim 1, wherein said means for connecting the upper part with the bottom part and enabling the bottom part to be rotated in the plane and be locked in different angles relative to the upper part is a cylinder with first grooves, wherein the cylinder comprises a surrounding limitation and having a second groove lockable by a wedge inserted into any of the first grooves.

5. A device according to claim 1, wherein the bottom part comprises means for designating the direction of the bottom part.

6. A device according to claim 5, wherein means for designating the direction of the bottom part is a visual arrow.

7. A device according to claim 5, wherein means for designating the direction of the bottom part is a visual line.

8. A device according to claim 1, wherein said means for generating the at least one additional control signal suitable to be transferred to the peripheral unit is a button located in the upper part.

9. A device according to claim 1, wherein said means for generating the at least one additional control signal suitable to be transferred to the peripheral unit is a scroll wheel.

10. A device according to claim 1 further comprising means for detecting movements of the device on the essentially flat surface is an optical sensor.

11. Use of a device according to claim 1 together with a peripheral unit (5), wherein a movement of said the device causes control of at least one entity of the peripheral unit.

12. Use of a device according to claim 1 together with a peripheral unit (5) including a computer and a display, where manipulation of the device causes a cursor or other graphic entity to move on said display.
